(19) United States
(12) Patent Application Publication
(10) Pub. No.: US 2020/0054005 A1
(43) Pub. Date: Feb. 20, 2020

(54) BIODEGRADABLE COMPOSITES AND METHODS OF USE IN ATTRACTING OR REPELLING ANIMALS

(71) Applicant: Green Dot Bioplastics Inc., Emporia, KS (US)

(72) Inventors: Mark Remmert, Emporia, KS (US); Mike Parker, Lawrence, KS (US); Christopher Michael Edwards, Midland, MI (US)

(21) Appl. No.: 16/540,567

(22) Filed: Aug. 14, 2019

Related U.S. Application Data
(60) Provisional application No. 62/718,679, filed on Aug. 14, 2018.

(51) Int. Cl. A01N 25/10; C08L 67/02; C08L 97/02; C08J 3/12; A01N 63/00; A01N 65/44; B29B 9/06

(52) U.S. Cl. CPC A01N 25/10; C08L 67/02; C08L 97/02; C08J 3/12; B29K 2067/006; A01N 65/44; B29B 9/06; C08L 2205/16; C08L 2201/06; A01N 63/00

(57) ABSTRACT

Described herein are biodegradable composites and methods of forming the same. The composites generally comprise a base polymer, a plant-based filler material, and optionally a fragrant additive. The fragrant additives may be used for attracting animals to or repelling animals from an area. Methods of forming the biodegradable composites include an extrusion process using a melt formed from the base polymer and the plant-based filler material.

### CROSS-REFERENCE TO RELATED APPLICATIONS

The present application claims the priority benefit of U.S. Provisional Application No. 62/718,679, filed Aug. 14, 2018, entitled BIODEGRADABLE COMPOSITES AND METHODS OF USE IN ATTRACTING OR REPELLING ANIMALS, incorporated by reference in its entirety herein.

### BACKGROUND OF THE INVENTION

The present invention is generally directed toward biodegradable composites that can be formulated with fragrant materials that are useful in attracting animals to or repelling animals from an area. Such composites are particularly suited for use by hunters to attract certain animals, such as deer, into an area in which the hunter desires to hunt the animals. Alternatively, the composites may be formulated with an animal-repelling fragrant material that can be used to drive an animal, which is considered to be a nuisance, away from a desired area.

### SUMMARY OF THE INVENTION

According to one embodiment of the present invention, there is provided a biodegradable composite comprising a base polymer selected from the group consisting of biodegradable aliphatic-aromatic copolyesters, biodegradable aliphatic polyesters, and thermoplastic starch, a plant-based filler material, and optionally a fragrant additive. In preferred embodiments, the biodegradable composite comprises from about 30% to about 60% by weight of the base polymer, from about 30% to about 70% by weight of the plant-based filler, and optionally from about 10% to about 30% by weight of a fragrant additive. certain embodiments, the plant-based filler comprises a biomass particulate material, such as wood flour, and a starch present in a relative weight ratio of from about 0.2:1 to about 1:1.

According to yet another embodiment of the present invention, there is provided a method of making a pelletized, biodegradable composite. The method comprises forming a melt within a heated extruder comprising a base polymer selected from the group consisting of biodegradable aliphatic-aromatic copolyesters, biodegradable aliphatic polyesters, and thermoplastic starch. The melt is then mixed, within the extruder, with quantities of a plant-based filler material to form the composite. In certain embodiments, the plant-based filler material comprises a mixture of starch and a biomass particulate material. The composite is extruded through a die of the extruder and then pelletized.

The composites described herein may be used to attract or repel an animal. Such methods involve placing in a location in which it is desired to attract an animal to or repel an animal from a quantity of a biodegradable composite as described herein.

### DETAILED DESCRIPTION OF THE PREFERRED EMBODIMENT

Embodiments of the present invention are directed to biodegradable composites comprising a base polymer, a plant-based filler material, and optionally a fragrant additive. In certain embodiments, the biodegradable composites consist of, or consist essentially of, the base polymer and the plant-based filler material. In certain other embodiments, the biodegradable composites consist of, or consist essentially of, the base polymer, the plant-based filler material, and the fragrant additive. As explained below, in certain embodiments, the plant-based filler material can function as both the filler and the fragrant additive, especially when the plant-based filler material naturally possesses fragrant characteristics (i.e., produces aromas that can be used to attract or repel an animal).

The following table summarizes exemplary biodegradable composites made in accordance with the present invention.

TABLE 1

| | Broad range | Intermediate range | Narrow range |
|---|---|---|---|
| Component | (wt. %) | (wt. %) | (wt. %) |
| Base polymer | 30-60% | 35-55% | 40-50% |
| Plant-based filler | 30-70% | 35-60% | 40-55% |
| *biomass | 5-15% | 7-13% | 9-11% |
| particulate material | | | |
| *starch | 25-50% | 30-45% | 32-47% |
| Fragrant additive | 0-30% | 10-25% | 15-20% |

*Preferred fillers, values based on total weight of the composite.

In certain embodiments, the base polymer is selected from the group consisting of biodegradable aliphatic-aromatic copolyesters, biodegradable aliphatic polyesters (e.g., polybutylene succinate (PBS), polyhydroxyalkanoates (PHAs), and polylactic acid (PLA)), and thermoplastic starch (TPS). Ecoflex® F Blend C1200 is a preferred biodegradable, aliphatic-aromatic copolyester that may be used in accordance with the present invention. It is based on the monomers 1,4-butanediol, adipic acid and terephthalic acid in the polymer chain. Ecoflex® F Blend C1200 will biodegrade to the basic monomers 1,4-butanediol, adipic acid and terephthalic acid and eventually to carbon dioxide, water and biomass when metabolized in the soil or compost under standard conditions. Ecoflex® F Blend C1200 has a density of 1.25-1.27 g/cm³, melting point of 110-120° C., a shore D hardness of 32, and a Vicat softening temperature of 91° C.

The plant-based filler material can be any absorbent, plant-derived material. In certain embodiments, the plant-derived material may be any biomass particulate material including wood fibers, wood flour, wood particulates (e.g., sawdust), agricultural waste materials, other cellulosic particulate materials such as starch, plant stalks, straw, cobs, and the like. In certain embodiments, the filler material comprises a mixture of biomass particulate materials, especially wood-based particulate material (e.g., wood flour) and starch. The starch used may be derived from any plant source such as wheat, potatoes, rice, tapioca, and the like, and may be unmodified (native) or modified through a chemical and/or physical process. In a particularly preferred embodiment, the starch comprises a wheat-based starch. In certain preferred embodiments, the plant-based filler comprises a biomass particulate material and a starch present in a weight ratio of from about 0.2:1 to about 1:1.

The fragrant additive may be any material that has exhibited usefulness in attracting or repelling an animal. Deer urine is a preferred attractant in certain embodiments of the invention. For example, several different types of deer urine, both synthetic and natural, can be used. These types of deer urine include natural doe in estrus urine, natural buck scrape urine, synthetic doe in estrus urine, and synthetic buck scent urine. In addition, a number of dry agricultural products and byproducts may be useful as animal attractants and repellants. Additional exemplary attractant materials include corn, corn cob, soybeans, (dehydrated) apple and synthetic apple scent, peach, blueberry, (dehydrated) beets or carrots, ground acorn, clover, alfalfa, and mast from persimmon, crabapple, honey locust, or sumac trees. Additional exemplary repellant materials include bone meal, fish meal, hot pepper, dried eggs, blood meal, wintergreen oil, and garlic oil. In certain embodiments, the plant-based filler material may also possess fragrant characteristics thereby eliminating the need for a separately added fragrant additive. For example, some of the cellulose-containing materials described above as possessing fragrant characteristics as animal attractants and repellants may also provide functionality as a filler. However, if a non-cellulosic or plant-derived fragrant additive is used, a separate plant-based filler material should be used.

In certain preferred embodiments, the biodegradable composite comprises a matrix that includes the base polymer (preferably, biodegradable aliphatic-aromatic copolyester), a biomass particulate material (preferably, a wood-based particulate material), and starch. In certain such embodiments, the composite further comprises the fragrant additive. In certain preferred embodiments, the fragrant additive is a liquid that has been absorbed by the matrix. In certain other preferred embodiments, the fragrant additive is a solid that is blended and forms a part of the matrix.

Other embodiments of the present invention are directed to a method of making a pelletized, biodegradable composite. The method preferably utilizes an extruding process and a heated extruder. The extruder barrel comprises a feed section, an elongate barrel section and the die. The extruder further comprises a screw. During certain embodiments of operation, the screw is operated at a speed of from about 100 to about 300 RPM. The method comprises first forming a melt within the heated extruder. The melt generally comprises a base polymer selected from the group consisting of biodegradable aliphatic-aromatic copolyesters, biodegradable polyesters, and thermoplastic starch. During operation, the temperature within the extruder, between the feed section and the die, is at least about 300° F. In particular embodiments, the feed section of the extruder is heated to a temperature of from about 325° F. to about 450° F.

The method next comprises mixing quantities of a plant-based filler material with the melt to form the composite within the extruder. In certain embodiments, the plant-based filler material is one of the materials described above. In certain preferred embodiments, the plant-based filler material has a moisture content of less than 2% by weight when mixed with the melt. In certain embodiments, the plant-based filler material is added to and mixed with the melt in the barrel section of the extruder. In particular embodiments, the barrel section of the extruder is heated to a temperature of from about 310° F. to about 425° F.

The method then comprises extruding the composite through the die. The die can be any shape, although in preferred embodiments the extruder die is circular. In particular embodiments, the temperature of the extruder at the die is from about 325° F. to about 450° F. The extruded composite can then be pelletized. In certain embodiments, the composite is pelletized using an underwater pelletizer, which can be configured to cool, cut, and dry the composite material into the desired form, such as pellets, balls, etc.

In certain embodiments, the method further comprises adding a fragrant additive to the composite. The fragrant additive may be added in any place throughout the extrusion and pelletizing process. The fragrant additive may be in solid or liquid form. In certain preferred embodiments, the fragrant additive is as solid that is added to the composite within the extruder. In certain other preferred embodiments, the fragrant additive is a liquid that is added to and absorbed by the pelletized composite.

In certain embodiments, the composite has a density of from about 1.2 to about 1.4 g/cm³, or from about 1.25 to about 1.35 g/cm³, or about 1.3 g/cm³. In certain embodiments, the composite may comprise one or more colorants. The colorants may be incorporated into the composite so that the composite may be camouflaged with respect to the environment in which it will ultimately be used. In other embodiments, the filler material itself may impart a natural camouflage appearance to the composite material so that it will difficult for the animal to visually detect the composite once deployed in the animal's habitat.

The composite may also be injection molded and formed into various shapes. For example, in certain embodiments, the composite may be molded into shapes having a high surface area to volume ratio. The greater the surface area, the more rapidly the fragrant additives or compounds can be released from the composite. In certain embodiments, the composite is preferably used in an outdoor, natural setting. Therefore, the composite may be molded into shapes resembling articles typically found in the intended area of use, such as leaf shapes, and provide for more rapid release of the fragrant materials present within the composite.

The composites may be used to bait or lure animals to a particular area for the purpose of hunting. The composites have the benefit in that they naturally degrade over a period of six months to a year, thereby minimizing impact to the environment in which they are used. Alternatively, the composites may be used to repel certain nuisance animals, when desired. For example, composites comprising an animal repellant fragrant additive can be used to keep rodents, squirrels, rabbits, opossums, raccoons, foxes, deer, and the like away from gardens or farms, and insects away from greenspace to be occupied by animals and humans. Therefore, certain embodiments are directed to a method of attracting or repelling an animal, wherein the method comprises placing a quantity of the biodegradable composite in a location in which it is desired to attract or repel

Additional advantages of the various embodiments of the invention will be apparent to those skilled in the art upon review of the disclosure herein and the working examples below. It will be appreciated that the various embodiments described herein are not necessarily mutually exclusive unless otherwise indicated herein. For example, a feature described or depicted in one embodiment may also be included in other embodiments but is not necessarily included. Thus, the present invention encompasses a variety of combinations and/or integrations of the specific embodiments described herein.

As used herein, the phrase “and/or,” when used in a list of two or more items, means that any one of the listed items can be employed by itself or any combination of two or more of the listed items can be employed. For example, if a composition is described as containing or excluding components A, B, and/or C, the composition can contain or exclude A alone; B alone; C alone; A and B in combination; A and C in combination; B and C in combination; or A, B, and C in combination.

The present description also uses numerical ranges to quantify certain parameters relating to various embodiments of the invention. It should be understood that when numerical ranges are provided, such ranges are to be construed as providing literal support for claim limitations that only recite the lower value of the range as well as claim limitations that only recite the upper value of the range. For example, a disclosed numerical range of about 10 to about 100 provides literal support for a claim reciting “greater than or equal to about 10” (with no upper bounds) and a claim reciting “less than or equal to about 100” (with no lower bounds).

### EXAMPLES

The following examples set forth composite materials and methods of use in accordance with embodiments of the present invention. It is to be understood, however, that these examples are provided by way of illustration and nothing therein should be taken as a limitation upon the overall scope of the invention.

### Example 1

### Materials:

ECOFLEX C1200 F Blend—Polybutylene Adipate Terephthalate (PBAT), from BASF
40 Mesh Pine Flour—from American Wood Fibers
Dried Wheat Starch—MIDSOL 50 from MGP Ingredients

### Deer Urine

### Equipment:

Berstorff ZE34×40D 34 mm twin screw extruder
Brabender loss-in-weight feeders

### Gala Underwater Pelletizer

The starch and wood flour were pre-dried to a moisture of less than 2%. The extruder was heated to 380° F. in the feed section, 360° F. on the barrel, and 380° F. at the die. The Gala water was at 70° F. The extruder speed was set at 200 RPMs. The plastic was fed to the extruder at the feed throat. The powders were fed about halfway down the extruder using a side feeder. The powders mixed with the melted polymer and formed a composite. The composite material exited the die and was pelletized in the Gala underwater pelletizer. The formulation of the pellets was as follows:

| | |
|---|---|
| PBAT | 50% |
| Starch | 40% |
| Wood | 10% |

The composite pellets were then dried to less than 0.1% moisture as measured using a moisture analyzer set to 160° C. for 15 minutes. Although, in certain embodiments, it may be acceptable to dry the composite pellets to a moisture content of 1% or less. It was then determined that the maximum moisture these pellets could absorb was 25% by weight. The pellets were placed into resealable containers in the desired amount and 25% by weight deer urine was added. Note, there are different types of deer urine that can be used to elicit different responses in the targeted population of animal. For example, general doe urine can be used to provide a sense of safety to other deer in that the area must be safe as another deer had passed through that location. Doe in estrus urine can be used, especially for a relatively short time during the peak of deer season, as it can attract bucks to an area for mating. Finally, buck urine can be used as it can elicit an aggressive or reckless response in bucks that may believe the odor is caused by a mating challenger. The pellets were agitated every few hours for 48 hours or until all the urine was absorbed. The impregnated pellets were then put into resealable pouches at about 8 ounces each and heat sealed closed. The final formulation for this product was as follows:

| | |
|---|---|
| PBAT | 40% |
| Starch | 32% |
| Wood | 8% |
| Deer Urine | 20% |

### Example 2

The pellets from Example 1 were tested for use as a deer attractant. Deer attractant pellets are best used on or near active scrape sites or active game trails. For this trial known scrape sites were used, where trail cameras were set up. Before the deer attractant pellets were placed, a few deer were observed to have visited the site every couple of days. Then, around noon, 8 oz. of pellets from Example 1 were placed in the center of the site in a small pile. That night, and throughout the next 3 days, many more deer visited the site, including a couple of bucks that had never before been seen on that land. Many of the deer visited multiple times during the test. After 3 days the number of visits appeared to decrease.

### Example 3

### Materials:

Polylactic acid (PLA)
Dried, ground corn cob

### Equipment:

Berstorff ZE34×40D 34 mm twin screw extruder
Brabender loss-in-weight feeders

### Gala Underwater Pelletizer

### SUMMARY

The extruder was heated to 380° F. at the feed section; 360° F. on the barrel; and 380° F. at the die. The Gala water was at 70° F. The extruder speed was set at 200 RPMs. The plastic was fed to the extruder at the feed throat. The corn cob was fed about halfway down the extruder using a side feeder. The powders mixed with the melted polymer and formed a composite. The composite material exited the die and was pelletized in the Gala underwater pelletizer. The formulation of the pellets was as follows:

| | |
|---|---|
| PLA | 40% |
| Dried, ground corn cob | 60% |

### Use:

The corn pellets are placed on the ground, in an area advantageous to the hunter. The natural corn smell of the pellets will help to attract the deer. The pellets will naturally degrade over time and are completely safe for the environment.

We claim:

1. A biodegradable composite comprising:
a base polymer selected from the group consisting of biodegradable aliphatic-aromatic copolyesters, biodegradable aliphatic polyesters, and thermoplastic starch;
a plant-based filler material; and
optionally, a fragrant additive.

2. The biodegradable composite of claim 1, wherein the composite comprises from about 30% to about 60% by weight of the base polymer.

3. The biodegradable composite of claim 2, wherein the base polymer is selected from the group consisting of polybutylene adipate terephthalate, polybutylene succinate, and polylactic acid.

4. The biodegradable composite of claim 1, wherein the composite comprises from about 30% to about 70% by weight of the plant-based filler material.

5. The biodegradable composite of claim 4, wherein the plant-based filler material comprises a mixture of a wood-based particulate material and starch.

6. The biodegradable composite of claim 5, wherein the composite comprises from about 5% to about 15% by weight of the wood-based particulate material.

7. The biodegradable composite of claim 5, wherein the wood-based particulate material is a wood flour.

8. The biodegradable composite of claim 5, wherein the composite comprises from about 25% to about 50% by weight of the starch.

9. The biodegradable composite of claim 5, wherein the starch comprises a wheat-based starch.

10. The biodegradable composite of claim 5, wherein the composite comprises a matrix that includes the base polymer, the wood-based particulate material, and the starch.

11. The biodegradable composite of claim 10, wherein the fragrant additive is a liquid that has been absorbed by the matrix.

12. The biodegradable composite of claim 10, wherein the fragrant additive is a solid that is blended and forms a part of the matrix.

13. The biodegradable composite of claim 1, wherein the composite comprises from about 10% to about 30% by weight of the fragrant additive.

14. The biodegradable composite of claim 1, wherein the fragrant additive is an animal attractant or an animal repellant.

15. The biodegradable composite of claim 1, wherein the composite has a density of from about 1.2 to about 1.4 g/cm³.

16. A biodegradable composite comprising:
from about 30% to about 60% by weight of a base polymer selected from the group consisting of biodegradable aliphatic-aromatic copolyesters, biodegradable polyesters, and thermoplastic starch;
from about 30% to about 70% by weight of a plant-based filler, wherein the plant-based filler comprises a biomass particulate material; and
optionally from about 10% to about 30% by weight of a fragrant additive.

17. The biodegradable composite of claim 16, wherein the base polymer is selected from the group consisting of polybutylene adipate terephthalate, polybutylene succinate, and polylactic acid.

18. The biodegradable composite of claim 16, wherein the biomass particulate material is a wood-based flour.

19. The biodegradable composite of claim 16, wherein the starch comprises a wheat-based starch.

20. The biodegradable composite of claim 16, wherein the fragrant additive is an animal attractant or an animal repellant.

21. The biodegradable composite of claim 16, wherein the composite comprises a matrix that includes the biodegradable aliphatic-aromatic copolyester, the biomass particulate material, and the starch.

22. The biodegradable composite of claim 21, wherein the fragrant additive is a liquid that has been absorbed by the matrix.

23. The biodegradable composite of claim 21, wherein the fragrant additive is a solid that is blended and forms a part of the matrix.

24. A method of making a pelletized, biodegradable composite comprising:
forming a melt within a heated extruder comprising a base polymer selected from the group consisting of biodegradable aliphatic-aromatic copolyesters, biodegradable polyesters, and thermoplastic starch;
mixing within the extruder quantities of a plant-based filler material with the melt to form the composite;
extruding the composite through a die; and
pelletizing the extruded composite material.

25. The method of claim 24, wherein the plant-based filler material has a moisture content of less than 2% by weight when mixed with the melt.

26. The method of claim 24, wherein the extruder barrel comprises a feed section, an elongate barrel section and the die, wherein the temperature within the extruder, between the feed section and the die, is at least 300° F.

27. The method of claim 26, wherein the feed section of the extruder is heated to a temperature of from about 325° F. to about 450° F.

28. The method of claim 26, wherein the barrel section of the extruder is heated to a temperature of from about 310° F. to about 425° F.

29. The method of claim 26, wherein the temperature of the extruder at the die is from about 325° F. to about 450° F.

30. The method of claim 26, wherein the extruder comprises a screw and wherein the screw is operated at a speed of from about 100 to about 300 RPM.

31. The method of claim 26, wherein the extruded composite material is pelletized using an underwater pelletizer.

32. The method of claim 26, wherein the method further comprises adding a fragrant additive to the composite.

33. The method of claim 32, wherein the fragrant additive is as solid that is added to the composite within the extruder.

34. The method of claim 32, wherein the fragrant additive is a liquid that is added to the pelletized composite.

35. A method of attracting or repelling an animal comprising placing in a location in which it is desired to attract an animal to or repel an animal from a quantity of a biodegradable composite according to claim 1.
